(19) United States
(12) Patent Application Publication
(10) Pub. No.: US 2011/0014323 A1
(43) Pub. Date: Jan. 20, 2011

(54) Method for the Automatable Production of Raw Sausage

(76) Inventors: Volker Heinz, Quakenbrück (DE); Fritz Kortschack, Berlin (DE)

Correspondence Address: Gerald T. Bodner;BODNER & O''ROURKE, LLP, 425 BROADHOLLOW ROAD, SUITE 120, MELVILLE, NY, 11747, US

(21) Appl. No.: 12/735,058

(22) PCT Filed: Nov. 24, 2008
(86) PCT No.: PCT/EP2008/066045

§ 371 Date: Sep. 29, 2010

(30) Foreign Application Priority Data
Dec. 13, 2007 (DE) 10 2007 059 993.7
Jan. 14, 2008 (DE) 10 2008 004 242.0

(51) Int. Cl. A23L 1/317

(52) U.S. Cl. 426/59

(57) ABSTRACT

The invention relates to a process for the automatable production of raw sausage by mincing and mixing parts or pieces of meat and adding starter cultures, spices or similar materials. According to the invention, the parts or pieces of meat are supplied as feed stock to the mincing and mixing space (14) over a transport system, especially a multi-piston/cylinder system (1, 2), which can be operated separately from the mincer on the drive side, as a function of the capacity of the mincer (5) or mincers (5) in such a manner, that damming up as well as an increase in temperature and, with that, damage to the feed stock, is avoided. A drying container (6), which takes up exchangeable adsorbents in order to take up water or water vapor from the material treated, is coupled to the mincing and mixing space. In the case of one embodiment, the pre-dried material, reduced in volume and having a loose structure, reaches a lower sheet (8) in scooped or weighed out portions; furthermore, an upper sheet (10) is applied and enclosed air is removed. The material or sausage meat remains exposed to a pressure treatment within a water-permeable film until the isoelectric point is reached in the material. In addition, the sausage meat in the film is subjected to a tempering treatment during the maturing phase, in order to control the activity of the microorganisms responsible for the maturing process. The pre-shaped sausage meat preforms are exposed to a high-pressure treatment in order to inactivate the microorganisms and then removed from the enveloping film, subjected to a drying step and then processed further.

The invention relates to a method for the automatable production of raw sausage by mincing and mixing parts or pieces of meat and adding starter cultures, spices or the like materials, according to the preamble of patent claim 1.

An automatic mincing and emulsifying apparatus for the production of sausage meat for durable raw sausages, cooked sausages, scalded sausages or the like with a selectable particle size of the sausage meat, which is fed in the form of large pieces of meat, to obtain the respective type of sausage meat for the final product is known from EP 0 835 608 B1.

This document describes that for the production of sausage products a mincing process is performed in mincing machines which operate according to the so-called mincer principle. The cooperation between technological method steps and constructive modifications of the employed machines determine the quality of the final product, but also the effectiveness during the production process itself.

The mincing process involves a feeding of the charging material on the one hand, and chopping up the charged components on the other hand. This means that the material to be minced is fed by specific feeding systems, specifically the feed screws, and undergoes a compression and, in this state, is fed to a cutting system which eventually performs the desired mincing. The mincing machines are based on a frictional transport, and the material compressed by the feed screws is separated, more specifically cut off, by means of the chopping knives. Accordingly, the material is compressively fed to the cutter set, with the feed screws being responsible for supporting and compressing the material to be minced.

It has shown, however, that during the compression, and also during the actual feeding step, the temperature in the treated material is inadmissibly increased. As a consequence thereof soft fat layers may get deposited in the sausage meat due to squeezing processes, which is a substantial drawback for the quality of the initial product. Also, a uniform extraction of water during the drying phase is impeded. These disadvantageous consequences are particularly due to the fact that, as a rule, the feed screws directly produce the rotary motion of the chopping means of the mincer, i.e. that a coupling is provided between the screw drive and the drive of the chopping means, e.g. of a rotating knife.

Although the teaching according to EP 0 835 608 B1 proposes to realize the drive of the cutter set of the mincer by an external drive shaft supported in the second feeding and cutting system, it is not recognized that it is basically an advantage to feed the material to be minced independently of the actual cutting system so as to ensure an optimum quality of the initial products.

A method is known from WO 98/26667 by means of which the pH-value of durable raw products can virtually be frozen by the influence of high pressure. The method introduced in this document claims that, once a specific pH-value is reached, the products are wrapped in a water-impermeable manner and are subjected after the maturing and partial drying to a high-pressure treatment lasting several minutes.

Based on the foregoing it is, therefore, the object of the invention to provide a further developed method for the automatable production of raw sausage by mincing and mixing parts or pieces of meat and adding starter cultures, spices or the like materials, which ensures a clean and high-quality cut appearance of the final product as well as a uniform extraction of water and, thus, drying of the product, by principally guaranteeing a careful treatment of the raw material.

The solution to the object of the invention is achieved with a method according to the teaching of patent claim 1. The dependent claims define at least useful embodiments and further developments.

According to the invention the parts or pieces of meat, which may have been chopped in advance, are fed as charging material to the mincing and mixing chamber by a conveying system, more specifically a multi-piston cylinder system, which can be operated separately from the actual mincer by a separate drive. The charging material is basically fed in dependence on the capacity of the downstream mincer(s). Thus, it is ensured that an undesired accumulation as well as a disadvantageous temperature rise and, with this, a damage to the charging material are avoided. The mincers may be gear extruders, specifically planetary gear extruders, which are adapted to the food processing requirements.

If it is necessary, for example because the charging material is difficult to mince, to reduce the fed quantity by the multi-piston cylinder system, this may be accomplished by a simple adjustment control. This means that the multi-piston cylinder system would always transfer and provide that quantity to the cutter sets of the mincer that can be processed according to the choice of the corresponding performance parameters of the mincer.

Additionally, the filling into a vacuum chamber is possible, wherein the flow speed in the cutting system is increased by the produced suction/vacuum effect. Apart from the increased quantity passing through the cutting system an evacuated sausage meat is produced at the same time, which needs no further vacuum treatment for the air removal therefrom. The drying container to be explained later may here also be used, simultaneously or alternatively, as vacuum chamber. The drying or vacuum container may be attachable and detachable.

In a preferred embodiment a drying container is coupled to the mincing and mixing chamber, which receives exchangeable adsorbents for absorbing water or water vapor from the treated material for the purpose of predrying.

It should be pointed out here that the predrying step during the production of sausage meat for scalded or cooked sausage may also be replaced by the addition of liquid into the mincing and mixing chamber.

Also, it is possible to carry out the predrying in a preceding coarse premixing step of the starting components.

The predried material, thus reduced in volume and having a loose structure, and after having been portioned and weighed, is then placed onto a lower film onto which an upper film is placed. Then, the entrapped air is removed. The aforementioned films are water-impermeable. Also, the use of a film envelope or film bag is possible.

The material or sausage meat is then formed, quasi inside the water-impermeable films, which can be done by means of a punch-type press body. The form punch remains on the material in terms of a pressure treatment, until the isoelectric point in the treated material is reached.

During the maturing phase the sausage meat located in the film is subjected to a targeted tempering treatment so as to control the activity of the microorganisms responsible for the maturing process. This temperature treatment can preferably take place in a liquid bath, more specifically in a water bath.

The pre-shaped sausage meat preforms are then subjected to a high-pressure treatment so as to inactivate the microorganisms, removed from the enveloping film afterwards, subjected to a final drying step and processed further.

In the mincing and mixing chamber the material can be exposed to a vacuum. Moreover, it is possible to connect a dosing feeder for the addition of auxiliary materials to the mincing and mixing chamber.

The tempering treatment in the liquid bath, more specifically water bath, is meant to either increase or reduce the temperature of the material to be treated. Due to the fact that the material is located in water-impermeable films the tempering liquid can contact the material on all sides so as to allow an optimum heating or cooling step with a reduced use of energy.

The predrying process in the mincing and mixing chamber and the water evaporation processes taking place during the same result in a targeted temperature reduction in the material. A temperature rise in the material caused by the cutting process is thus at least compensated.

Eventually the sausage meat preforms removed from the enveloping film can be subjected to an after-treatment in order to modify the taste and/or appearance. This after-treatment can be accomplished with liquid smoke, spices and/or edible mold or the like.

The invention shall be explained in more detail below by means of an embodiment and with the aid of a schematic diagram.

As was explained before, the treated material is fed into the mincing and mixing chamber independently of the actual cutting system, which is preferably realized by a double-piston system.

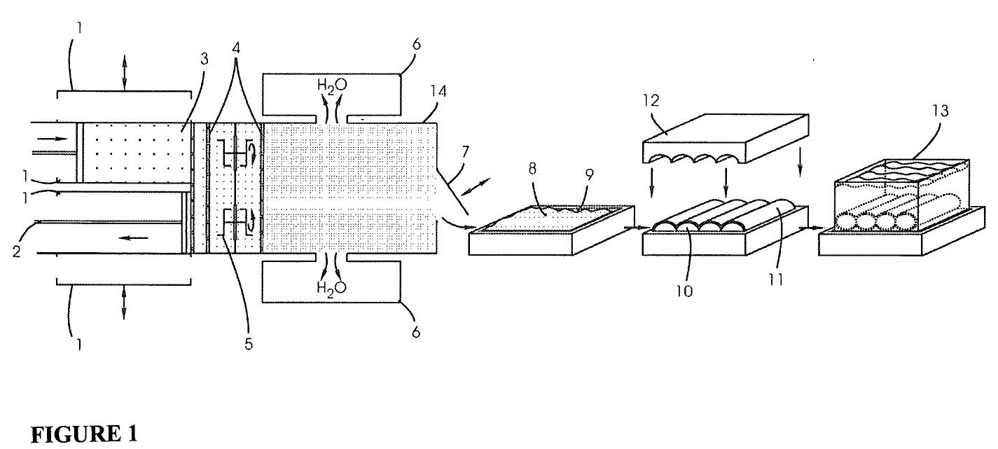

According to the illustration shown in FIG. 1 the double-piston conveying system is comprised of a combination of semi-cylinder shells. The semi-cylinder shells 1 can be opened so as to allow the alternate feeding of material and a quasi continuous charge of the mincers 5 in the mincing and mixing chamber 14.

The conveying means comprises a combination of piston rods with pistons 2, which have a non-illustrated drive. The illustrated arrows symbolize the direction of motion of the piston rod with piston 2, and the double arrows illustrate the opening and closing of a corresponding semi-cylinder shell 1 of the respective cylinder space.

On the output side of the conveyor perforated discs 4 are disposed, through which the charging material is passed in order to be exposed to the action of the mincers 5. These mincers can comprise, for example, rotating knives, which are driven separately from and independently of the double-piston conveyor. For the production of fine sausage meat extruders, more specifically planetary gear extruders may be used for the mincing. The use of a planetary gear extruder also allows the grinding of critical coarse components, more specifically collagens, and the air input is minimized in comparison with prior cutter methods. This means that the quality of the obtained final product is enhanced. According to FIG. 1 the mincing and mixing chamber 14 is one single compact chamber. However, it is basically possible to differentiate between a receiving chamber and an actual mincing chamber, and to provide a coupling between these two vessels or chambers. This permits the use of different mincers, such as the aforementioned extruders or also a classical mincer. This means, depending on the product to be processed, it is possible to easily convert the device necessary for realizing the method and adapt same to the respective situations.

This configuration permits an optimum adjustment of the feed and flow speed of the charging material to the respective characteristics, so that damages to the material caused by pressure and/or friction can be avoided. The independently operated mincers 5 are fed with pre-chopped starting components 3 in exactly the quantity that can be minced. An accumulation of raw materials ahead of or between the mincers 5 is impossible.

Successively disposed pre-cutters, knives and perforated discs, which are not illustrated in detail, permit a flow of charging material to be processed to a limited extent independently of the composition of the raw material, the number of revolutions of the knives or discs, the arrangement of the knives and discs relative to each other and the geometry thereof.

The separate advancing and conveying unit and the independently driven cutting and mincing device allow a great number of processing options, viz. from clean cutting to finest comminution and emulsification of the material to be processed.

It is known that the extraction of water, that is, the reduction of the so-called aw-value, and the acidification of the raw material, i.e. the adjustment of the pH-value, are likewise decisive for the stability of raw sausage products.

In order to obtain a desired drying in terms of a predrying step a drying container 6 is coupled to the mincing and mixing chamber 14, which is provided with adsorbents and is connected, in one embodiment, to a vacuum-generating unit. The mincing and mixing chamber 14 may also be comprised of coupleable, separate vessels or bodies. This permits the use of different mincers to be selected according to the type of product, e.g. a cutter or an extruder.

Due to its hygroscopically acting ingredients such a quasi active drying container 6 causes the free water in the minced raw materials to be transported very fast in the gaseous state from the material to be treated to the drying device. A particular advantage is that the evaporation of the water in the treated material produces an evaporation cold which counteracts the temperature rise in the product.

The starter cultures for the fermentation, which are necessary for the production of raw sausage, require a defined aw-value for the activities thereof. Depending on the composition of the starting materials and raw materials attention must be paid to observing a maximally reasonable drying rate.

By determining the weight gain in the drying container during the drying process the time can be determined as of which a continued drying would undesirably affect the activities of the microorganisms. At this time the drying container can be separated from the mincing and mixing chamber, or they may be closed.

It should be pointed out that the mincing and mixing chamber 14 may comprise mincers operating according to the mincing principle, on the one hand, but may also be realized in the form of a known cutter.

On the output side of the mincing and mixing chamber 14 the material, now having a relatively loose structure, is then withdrawn through a removal opening 7, and is placed with a precise weight onto a frame lined with a lower film 8, or is filled into a film bag.

An upper film 10 encloses the material. Entrapped air is then preferably removed by applying a vacuum, and films 8 and 10 are firmly connected with each other on their edges.

By approaching a pressure body 12 the received sausage meat is distributed in the space defined by the frame and is shaped as desired to obtain, for example, strings of equal thickness and length. To this end, the pressure body 12 may have a corresponding structuring on the side, which comes in contact with the upper film 10 and, thus, with the material 9. Of course, it is also possible for the frame to receive a mold plate, with the lower film 8 then lying on this mold plate and receiving the material 9.

During the maturing phase a pressure is exerted on the material 9, on the one hand for shaping and compression purposes, on the other hand for reaching the isoelectric point.

In order to support the function of the film used for shaping the sausage meat and the pressure to be exerted on the sausage meat until the isoelectric point of about pH 5.4 or the desired final pH-value of 5.2 is reached, a reusable mold may additionally be employed, e.g. on the basis of a second film wrapping.

During the maturing phase the shaped material 11 is further subjected to a tempering treatment, which is accomplished, for example, with a heated liquid, more specifically water. For this purpose the film materials used are water-impermeable. Also, it is precluded that the raw products are undesirably contaminated with germs, or that the aw-value is increased which is detrimental to the quality.

If the desired pH-value is reached, which signalizes the corresponding protein denaturation, the tempering liquid can be used as cooling medium for the water-impermeably enveloped raw sausage preforms. By this, too, the activity of the microorganisms can be controlled.

As a result of this treatment the pH-value should be adjusted to the desired value of the acidification, approximately pH 5.2, so as to carry out a targeted inactivation of the microorganisms by a high-pressure treatment.

According to the preceding description the maturing process can be integrated into the production more easily and inexpensively, without employing—as is common in the prior art—energy-consuming climatic chambers. These climatic chambers also have the disadvantage that the temperature-controlled air necessary for the heating of the sausage meat, the relative air humidity of which has to be preadjusted in order to avoid drying edges, has to be subjected to a complicated germ-reducing treatment.

In order to conclude the production process of the raw sausage the preforms are removed from the tempering bath 13 and subjected to a drying step. To this end, the combination of lower and upper film 8; 10 is opened, and the preform is placed onto a water-permeable mold and introduced into a drying chamber in which a vacuum can be generated facultatively. The water emerging from the preforms to the surface thereof as a result of the vacuum is transformed to the vapor state more quickly. In this case, too, the removal of the water can be supported by the use of adsorbents. The final drying process described above prevents microorganisms from settling on the surface of the raw sausage preforms. Upon reaching the desired degree of drying the surface of the raw sausage preforms can then be treated, for example, with liquid smoke, edible mold or similar substances.

The product is now ready for marketing and may be subjected to further processing, for example, for the production of packages for cold cuts.

### LIST OF REFERENCE NUMBERS

1 semi-cylinder shells
2 piston rod with piston
3 pre-chopped starting components
4 perforated disc
5 mincer comprising rotating knives
6 drying container filled with adsorbents
7 removal opening
8 lower film
9 material
10 upper film
11 shaped material
12 pressure body
13 tempering bath, if required in combination with high-pressure treatment
14 separable mincing and mixing chamber

1. Method for the automatable production of raw sausage by mincing and mixing parts or pieces of meat and adding starter cultures, spices or the like materials,
characterized in that
the parts or pieces of meat are fed as charging material to the mincing and mixing chamber by a conveying system, more specifically a multi-piston cylinder system, which can be operated separately from the mincer by a separate drive, in dependence on the capacity of the downstream mincer(s), said feeding being realized in such a manner that an accumulation as well as a temperature increase and, with this, a damage to the charging material are avoided,
a drying container is coupled to the mincing and mixing chamber, which receives exchangeable adsorbents for absorbing water or water vapor from the treated material,
the predried material, reduced in volume and having a loose structure, and after having been portioned or weighed, is filled into a film bag or placed onto a lower film, an upper film is placed thereon and entrapped air is removed,
the material or sausage meat is then formed inside the water-impermeable films and remains exposed to a pressure treatment until the isoelectric point in the material is reached,
during the maturing phase the sausage meat located in the film is subjected to a tempering treatment so as to control the activity of the microorganisms responsible for the maturing process,
and that the pre-shaped sausage meat preforms are subjected to a high-pressure treatment so as to inactivate the microorganisms, removed from the enveloping film afterwards, subjected to a drying step and processed further.

2. Method according to claim 1,
characterized in that
the material is exposed to a vacuum in the mincing and mixing chamber.

3. Method according to claim 1,
characterized in that
a dosing feeder for the addition of auxiliary materials is connected to the mincing and mixing chamber.

4. Method according to claim 1,
characterized in that
the predrying process in the mincing and mixing chamber results in a targeted temperature reduction in the material due to the water evaporation process taking place.

5. Method according to claim 1,
characterized in that
the tempering treatment takes place in a liquid bath, more specifically in a water bath, the tempering medium serving a temperature increase or temperature reduction in the treated material.

6. Method according to claim 1,
characterized in that
the sausage meat preforms removed from the enveloping film are subjected to an after-treatment in order to modify the taste and/or appearance.

7. Method according to claim 6,
characterized in that
an after-treatment is accomplished with liquid smoke, spices and/or edible mold.

8. Method according to claim 1,
characterized in that
the predrying step during the production of sausage meat for scalded or cooked sausage is replaced by the addition of liquid.

9. Method according to claim 1,
characterized in that
the predrying is carried out in a preceding premixing step of the starting components.

10. Method according to claim 1,
characterized in that
the material is subjected to a controlled drying process in the mincing and mixing chamber, wherein, in order to control the drying process, the weight of the drying container is determined so as to determine the quantity of liquid received in the same.

11. Method according to claim 1,
characterized in that
a vacuum can be generated in the mincing and mixing chamber so as to accelerate the transport of the material through the mincer(s).

12. Method according to claim 2,
characterized in that
a dosing feeder for the addition of auxiliary materials is connected to the mincing and mixing chamber.

13. Method according to claim 2,
characterized in that
the predrying process in the mincing and mixing chamber results in a targeted temperature reduction in the material due to the water evaporation process taking place.

14. Method according to claim 3,
characterized in that
the predrying process in the mincing and mixing chamber results in a targeted temperature reduction in the material due to the water evaporation process taking place

15. Method according to claim 2,
characterized in that
the tempering treatment takes place in a liquid bath, more specifically in a water bath, the tempering medium serving a temperature increase or temperature reduction in the treated material.

16. Method according to claim 3,
characterized in that
the tempering treatment takes place in a liquid bath, more specifically in a water bath, the tempering medium serving a temperature increase or temperature reduction in the treated material.

17. Method according to claim 4,
characterized in that
the tempering treatment takes place in a liquid bath, more specifically in a water bath, the tempering medium serving a temperature increase or temperature reduction in the treated material.

18. Method according to claim 2,
characterized in that
the sausage meat preforms removed from the enveloping film are subjected to an after-treatment in order to modify the taste and/or appearance.

19. Method according to claim 3,
characterized in that
the sausage meat preforms removed from the enveloping film are subjected to an after-treatment in order to modify the taste and/or appearance.

20. Method according to claim 4,
characterized in that
the sausage meat preforms removed from the enveloping film are subjected to an after-treatment in order to modify the taste and/or appearance.
